(19) United States
(12) Patent Application Publication
(10) Pub. No.: US 2005/0179607 A1
(43) Pub. Date: Aug. 18, 2005

(54) Method and apparatus for dynamically selecting the best antennas/mode ports for transmission and reception

(75) Inventors: Thomas Eric Gorsuch, Merritt Island, FL (US); Bing A. Chiang, Melbourne, FL (US); Michael James Lynch, Merritt Island, FL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/035,573

(22) Filed: Jan. 14, 2005

Related U.S. Application Data
(60) Provisional application No. 60/536,350, filed on Jan. 14, 2004.

(51) Int. Cl. H01Q 3/22

(52) U.S. Cl. 343/754; 343/853; 342/372

(57) ABSTRACT

A method and apparatus for dynamically selecting antennas for transmission and/or reception. The apparatus may be an antenna system, a base station, a wireless transmit/receive unit (WTRU), and/or an integrated circuit (IC). A subset of a plurality of antennas available for use is determined at any given moment in time. The antennas may be comprised by a Shelton-Butler matrix fed circular array including a plurality of selectable mode ports. One or more characteristics, (e.g., antenna cross-correlation, multipath), of antenna signals received via the antennas/mode ports are analyzed on a continual basis, and the number of available antennas/mode ports needed for transmission and/or reception is determined. At least one of the available antennas/mode ports associated with at least one received antenna signal having a better characteristic than the other received antenna signals is selected. The at least one selected antenna/mode port is then used for transmission and/or reception.

### CROSS REFERENCE TO RELATED APPLICATION(S)

This application claims priority from U.S. provisional application No. 60/536,350, filed Jan. 14, 2004, which is incorporated by reference as if fully set forth.

### FIELD OF THE INVENTION

The present invention relates to multiple-input multiple-output (MIMO) antenna schemes for wireless communication systems. More particularly, the present invention is related to employing various techniques to dynamically select the best antennas to use based on the characteristics of received antenna signals, such as antenna cross-correlation, or the amount of multipath in the signals.

### BACKGROUND

Improving the capacity of a wireless communication system is perhaps one of the most important areas in cellular technology that requires further exploration. Deficiencies in the spectral efficiency and power consumption of mobile systems have motivated wireless communication system designers to explore new areas in the technology that will offer capacity relief. One of these new areas is the use of antenna arrays in wireless systems to improve system capacity.

Antenna arrays deal with using multiple antenna elements at a receiver and/or transmitter to improve the capacity of the system. For example, using multiple antennas in a wireless receiver offers diversity of received signals. This proves to work well in fading environments and multi-path environments, where one path of a signal received by one antenna of the receiver may be subjected to difficult obstacles. In this scenario, the other antennas of the receiver receive different paths of the signal, thus increasing the probability that to receive a better component of the signal, (i.e., a less corrupt version of the signal), may be received.

One of the challenges facing the use of antenna arrays is that they usually require a high degree of computational complexity. This is because the system will attempt to process each signal at each antenna by a separate digital baseband processing element which may lead to excessive power consumption, hardware resources, and processing time.

MIMO is a technology that is being considered by different industry drivers for use in many different communications applications. MIMO antenna systems establish radio links by utilizing multiple antennas in an intelligent manner at the receiver side and the transmitter side. However, in conventional MIMO antenna systems, it is not possible to dynamically select between different ones of the antennas in a way that would substantially optimize the performance of the system when transmitting and receiving communication signals.

### SUMMARY

The present invention is related to a method and apparatus for dynamically selecting antennas for transmission and/or reception. The apparatus may be an antenna system, a base station, a WTRU, and/or an integrated circuit (IC). A subset of a plurality of antennas available for use is determined at any given moment in time. The antennas may be comprised by a Shelton-Butler matrix fed circular array including a plurality of selectable mode ports. One or more characteristics, (e.g., antenna cross-correlation, multipath), of antenna signals received via the antennas/mode ports are analyzed on a continual basis, and the number of available antennas/mode ports needed for transmission and/or reception is determined. At least one of the available antennas/mode ports associated with at least one received antenna signal having a better characteristic than the other received antenna signals is selected. The at least one selected antenna/mode port is then used for transmission and/or reception.

### BRIEF DESCRIPTION OF THE DRAWINGS

A more detailed understanding of the invention may be had from the following description, given by way of example and to be understood in conjunction with the accompanying drawings wherein:

FIG. 1 is a block diagram of a MIMO antenna system configured in accordance with the present invention;

FIG. 2 is a flow diagram of a process including method steps for dynamically selecting antennas in the MIMO antenna system of FIG. 1;

FIG. 3A shows a Shelton-Butler matrix; and

FIG. 3B shows a circular array fed by the matrix of FIG. 3A.

### DETAILED DESCRIPTION OF THE PREFERRED EMBODIMENT(S)

The present invention may be implemented in a WTRU or in a base station. The terminology “WTRU” includes but is not limited to user equipment (UE), a mobile station, a fixed or mobile subscriber unit, a pager, or any other type of device capable of operating in a wireless environment. The terminology “base station” includes but is not limited to a Node-B, a site controller, an access point or any other type of interfacing device in a wireless environment.

In one embodiment of the present invention, a multiple-isolated-beam smart antenna array with a small form factor forms a MIMO antenna. This is different from traditional antenna arrays, in that it uses efficient (fast and low-loss) electronic phase switching to form multiple optimum (reconfigurable) beam patterns that are uncorrelated, and can yield the theoretical high performance gains when implemented. In addition, this antenna design will result in a much smaller form factor compared to antenna arrays with typical antenna separation. The multi-beam antenna uses a center reflector and its form factor for MIMO.

The features of the present invention may be incorporated into an IC or be configured in a circuit comprising a multitude of interconnecting components.

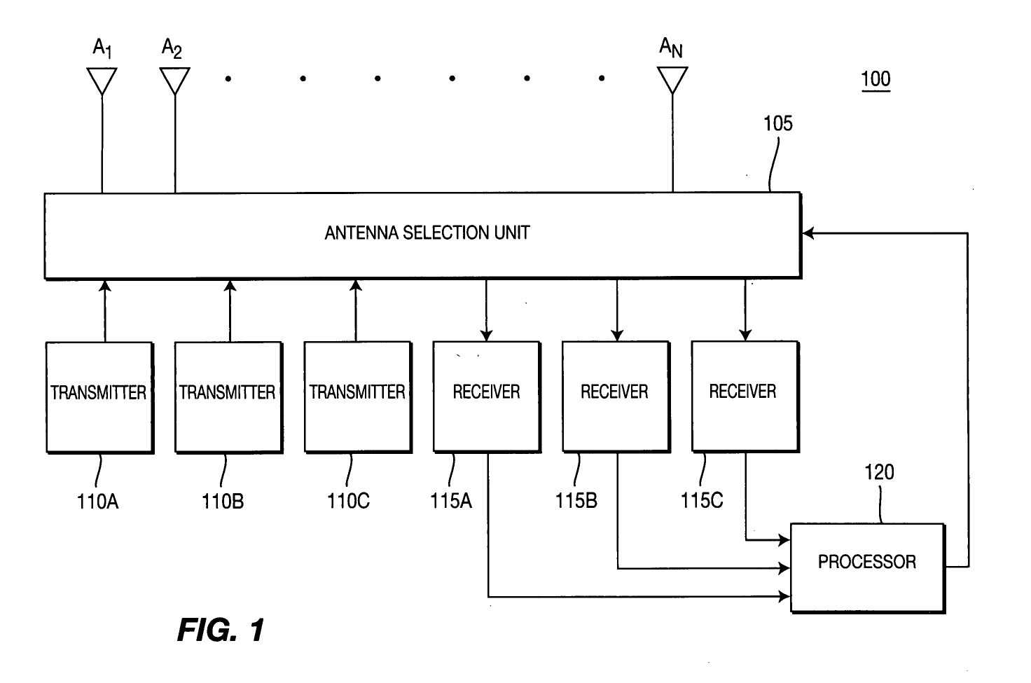

FIG. 1 shows a block diagram of a MIMO antenna system 100 which includes a plurality of antennas A₁, A₂, . . . , A_{N}, an antenna selection unit 105, a plurality of transmitters 110A, 110B and 110C, a plurality of receivers 115A, 115B and 115C, and a processor that analyzes antenna signals received by the receivers 115A, 115B and 115C and controls the antenna selection unit 105 accordingly. Any number of transmitters and/or receivers may be incorporated into the system 100, depending upon the particular application the system 100 is currently being used for.

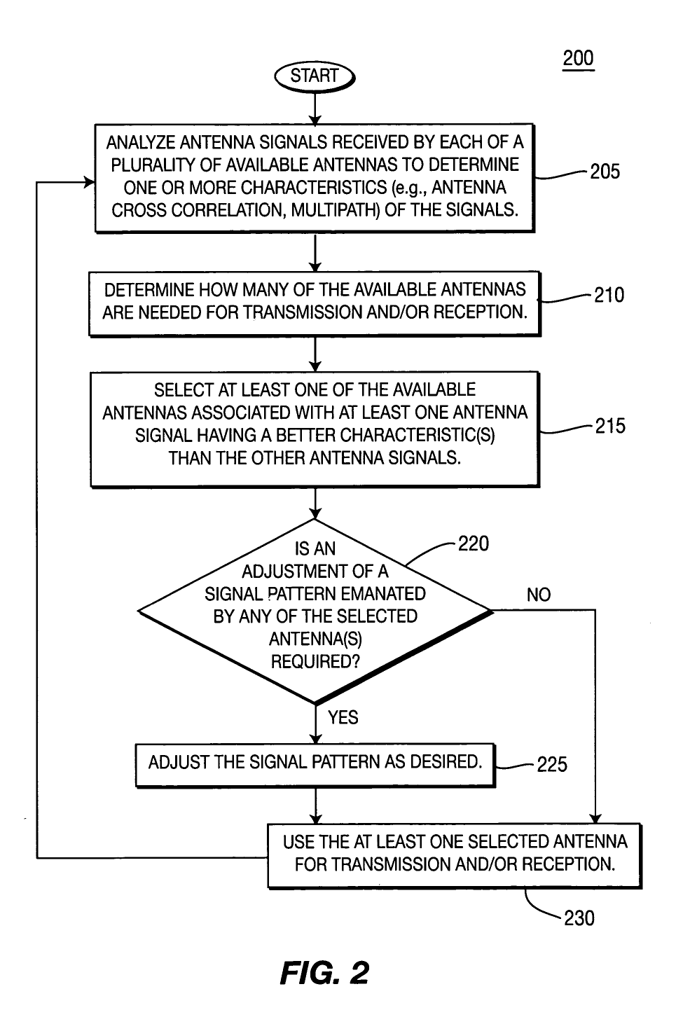

FIG. 2 is a flow diagram of a process 200 including method steps of determining a subset of the plurality of antennas A₁, A₂, . . . , A_{N} in system 100 available for use by the transmitters 110 and/or the receivers 115 at any given moment in time. Referring to both FIGS. 1 and 2, antenna signals received by each of the plurality of antennas A₁, A₂, . . . , A_{N} are forwarded to the receivers 115. The received antenna signals are analyzed by the processor 120 on a continual basis to determine the characteristic(s), (e.g., antenna cross-correlation, multipath), of antenna signals associated with respective ones of the antennas. The processor 120 then determines which of the antennas A₁, A₂, . . . , A_{N} exhibit the best performance.

In step 210, the processor 120 determines how many of the available antennas A₁, A₂, . . . , A_{N} are needed for transmission and/or reception. In step 215, the processor 120 sends a control message to the antenna selection unit 105 to select at least one of the available antennas A₁, A₂, . . . , A_{N} exhibiting the best performance. For example, the antennas A₂ and A_{N} may be selected because they are associated with received antenna signals having the lowest cross-correlation properties. High isolation between antennas will typically yield lower correlation in antenna signals.

In step 220, a determination is made as to whether or not a signal pattern emanated by any of the selected antennas is required and, if so, the signal pattern is adjusted as desired in step 225, (e.g., by making a change to the selected antenna, such as switching in a different impedance, to change the profile or pattern of signal energy emanating from or collected by the selected antenna). Finally, in step 230, the at least one selected antenna is used by a transmitter 110 for transmission and/or is used by a receiver 115 for reception. Steps 205-230 are continually repeated such that the system 100 always has up-to-date information indicating the best antennas to use under various conditions.

The particular ones of the antennas A₁, A₂, . . . , A_{N} that the transmitters 110 and the receivers 115 are connected to constantly change. As an example, for a mobile environment, the antenna-to-transmitter and antenna-to-receiver connections may change every 100 ms. Antenna cross-correlation algorithms are executed in the processor 120 to identify sub-sets of the antennas A₁, A₂, . . . , A_{N} with low cross-correlation properties, such that only those sub-sets are used for data estimation at a given time. This has the potential to reduce complexity while maintaining good performance. The algorithm performs measurements by calculating the cross-correlation between the antennas A₁, A₂, . . . , A_{N} and selecting the antennas having the lowest cross-correlation. Furthermore, it may be desirable for the system to transmit using one subset of the antennas A₁, A₂, . . . , A_{N}, and receive using a different set of the antennas A₁, A₂, . . . , A_{N}.

Cross-correlation may be performed by the processor 120 based on a first variance of a signal received by an antenna. Two signals having substantially different variances would have a lower cross-correlation. Alternatively, the two signals could be slid past each other to determine what the cross-correlation is, where the cross-correlation value is between 0 and 1. If the signals are orthogonal to each other, a cross-correlation value of 0 results.

Analysis by the processor 120 may also be performed to determine the amount of multipath in the received antenna signals. Normally, a higher multipath may be considered to promote better MIMO performance. However, in some cases a lower multipath may be desired, such as when the amount of multipath is causing significant destructive fading.

Early antennas used in demonstrating MIMO were monopoles and dipoles. In order to assure sufficient isolation between them, antenna elements were spaced a few wavelengths apart. This forced the array to be large. The arrangement of the early arrays were planar, with the understanding that the waves traveled to the array came from one direction, which is contrary to the intention of MIMO, where system performance at its best is in a multi-path rich environment, which means that the waves are coming from different directions. A circular array is thus more suitable. The requirement for isolation remains.

When a reflector is placed between two antennas, it isolates the antennas. In a circular array, when a pole reflector is placed in the center, it has the tendency to isolate all the antennas from each other. The strongest isolation comes from elements that are in the same line with the reflector.

In one embodiment, a circular array includes four elements with a reflecting pole in the center. The resulting beam patterns of the four antennas has a null that is always in the direction of the pole reflector. With the higher isolation, seen as deep nulls in the beam patterns, the elements can be moved closer together. The result is a smaller cluster of independent antennas suitable for MIMO use. Isolation between adjacent elements can also be increased by adding a reflector between the antennas, in addition to the pole in the center.

Refining the idea on improving isolation between adjacent elements, based on the principle of wave diffraction at sharp edges, is to be disclosed below. The concept makes use of a vertical strip of reflector, placed in between the two adjacent antennas that need to be isolated, with the plane of the strip perpendicular to the line joining the radiation centers of the two antennas. The path of coupling is thus split into two, one on either side of the strip. If the path lengths are not equal, then there is a wave cancellation due to phase misalignment. At the extreme, when the two path lengths are half-wave length apart, and the split waves are equal in amplitude, then a complete cancellation is achieved, yielding perfect isolation. This type of array can thus form the basis of a good MIMO antenna system.

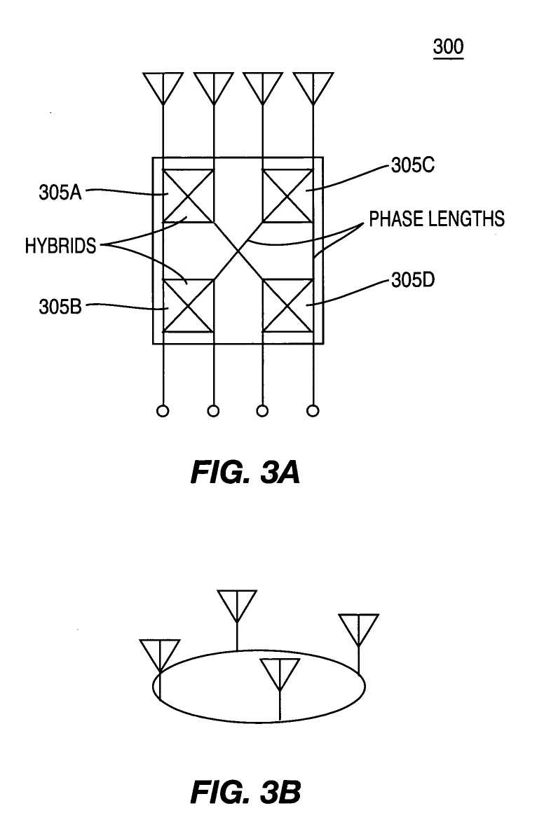

FIG. 3A shows a Shelton-Butler matrix 300 which forms omni-directional pancake-shaped beam patterns. The wave on the plane parallel to ground can provide phasing that narrows the elevation beamwidth, similar to that found in a surface wave structure, such as a Yagi array. The matrix can also be devices that have the same distribution characteristic, (e.g., a Rotman Lens).

Matrix 300 consists of hybrids 305A, 305B, 305C, 305D, and fixed phase shifters which can be line-lengths (not shown for clarity). A 4 port matrix is shown, but it can be 2 ports, 3 ports, 4 ports, 6 ports, etc.

To improve on the utility of such an isolated circular array of antennas, one can utilize the property of a Butler matrix. Keep in mind that there is a parallel between the Butler matrix and orthogonal frequency division multiplexing (OFDM), in that they both utilize symmetrical phasing to form orthogonal modes, and synthesis can be done through Fast Fourier Transform. Some of the properties described below by using Butler matrix can be used in OFDM. The properties of such an array can be extended for use with MIMO. The advantages include small size, aperture reuse for multiple mode formation, simultaneous beams, simplified pattern synthesis (adaptive beam shaping) using Fourier Transform, and much more.

FIG. 3B shows a Butler-matrix-fed circular array that can be fed by the matrix 300 shown in FIG. 3A. The antenna elements can consist of just about any type with any polarization. In such an array, each output port has a unique combination of all input antenna ports, called modes. These modes have characteristics of a harmonic series and therefore the system can be implemented using a fast Fourier transform (FFT) engine. This is especially important in integrating the MIMO system 100 with the OFDM based air interface. Since both MIMO processing and OFDM sub-carrier generation can be done with the help of an FFT engine, there is opportunity to formulate low cost implementations.

It is also possible to take this concept a step further and generate a series of beams offset in angles by using a cascade of Butler-matrix operations back to back, one controlling mode ports of the other. In short any beam shape and number of beams can be electronically synthesized using this innovative technique, and what's more, this is done in a compact antenna array.

A circular array that makes use of reflectors to assure isolation between elements, improve MIMO performance, and keep array size very compact is referred to as a Subscriber Based Smart Antenna (SBSA). Smart antenna designs typically include an antenna array where each antenna signal is downconverted by a different radio frequency (RF) transceiver and the signals are then processed jointly in baseband. Since there is a need to have as many RF chains as the number of antenna elements, this leads to a certain complexity in implementation.

Smart antenna technology can be used with a single RF transceiver and therefore leads to significantly lower cost, compact, high performance, and low complexity. An SBSA has a low-loss antenna architecture and has a printed-circuit implementation. The antenna generates omni directional as well as steered directive beams that are controlled through a digital control line from the baseband. Examples of this antenna has been implemented for WLAN and PCS mobile phones and tested in the field using commercial devices. The compact size of the antenna is an advantage especially for handheld devices.

The antenna has a center omni element and two outer elements that are switched in or out to form reflectors in order to create beam patterns with nulls in the desired direction. The antenna assembly has only one RF lead. By switching antenna elements on or off, antenna patterns are generated. Antenna beam patterns formed by an SBSA may have four or more elements which generate any number of antenna beam patterns offset in angle.

SBSA performance for mobile terminals in the field at 800 MHz and 1.9 GHz bands both indoors and outdoors is a substantial improvement over prior art systems. SBSA provides exceptional interference rejection and increases reliability of connections all the way to the edge of the coverage area. In addition SBSA increases the coverage by up to a factor of two times capacity increase and 50% reduction in required transmit power for the same link quality. SBSA will evolve by including a multiple layer switching network in the antenna assembly and allowing multiple control lines to form independent, uncorrelated beams. Furthermore, a Butler-matrix based switching of signals will be implemented.

While the present invention has been described in terms of the preferred embodiments, other variations which are within the scope of the invention as outlined in the claims below will be apparent to those skilled in the art.

1. In an antenna system comprising a plurality of antennas available for receiving and transmitting antenna signals, a method comprising:
(a) analyzing signals received by the antennas;
(b) based on at least one signal characteristic, determining at least one of the antenna signals that is better than other ones of the antenna signals for receiving or transmitting; and
(c) selecting at least one antenna associated with the at least one better antenna signal determined in step (b).

2. The method of claim 1 wherein the antennas are comprised by a Shelton-Butler matrix fed circular array including a plurality of selectable mode ports.

3. The method of claim 1 wherein the signal characteristic is antenna cross-correlation.

4. The method of claim 3 wherein the at least one antenna signal determined in step (b) has a lower cross-correlation characteristic than the other antenna signals.

5. The method of claim 4 wherein cross-correlation measurement values vary between 0 and 1, where a result of 0 indicates that two signals measured to determine cross-correlation are orthogonal to each other.

6. The method of claim 1 wherein the signal characteristic is associated with the amount of multipath in the antenna signals.

7. The method of claim 6 wherein the at least one antenna signal determined in step (b) has higher multipath than the other antenna signals.

8. The method of claim 1 further comprising:
(d) determining how many of the available antennas are needed for at least one of receiving and transmitting the antenna signals.

9. The method of claim 1 further comprising:
(d) determining whether or not antenna patterns emanated by the at least one selected antenna need to be adjusted; and
(e) adjusting the signal patterns if an adjustment is needed as determined in step (d).

10. The method of claim 1 wherein the antenna system is a multiple-in multiple-out (MIMO) antenna system.

11. An antenna system comprising a plurality of antennas available for receiving and transmitting antenna signals, the system comprising:
(a) means for analyzing signals received by the antennas;
(b) means for determining, based on at least one signal characteristic, at least one of the antenna signals that is better than other ones of the antenna signals for receiving or transmitting; and
(c) means for selecting the at least one antenna associated with the at least one better antenna signal determined by the determining means.

12. The system of claim 11 wherein the antennas are comprised by a Shelton-Butler matrix fed circular array including a plurality of selectable mode ports.

13. The system of claim 11 wherein the signal characteristic is antenna cross-correlation.

14. The system of claim 13 wherein the at least one antenna signal determined by the determining means has a lower cross-correlation characteristic than the other antenna signals.

15. The system of claim 14 wherein cross-correlation measurement values vary between 0 and 1, where a result of 0 indicates that two signals measured to determine cross-correlation are orthogonal to each other.

16. The system of claim 11 wherein the signal characteristic is associated with the amount of multipath in the antenna signals.

17. The system of claim 16 wherein the at least one antenna signal determined by the determining means has higher multipath than the other antenna signals.

18. The system of claim 11 further comprising:
(d) means for determining how many of the available antennas are needed for at least one of receiving and transmitting the antenna signals.

19. The system of claim 11 further comprising:
(d) means for determining whether or not signal patterns emanated by the at least one selected antenna need to be adjusted; and
(e) means for adjusting the signal patterns if an adjustment is needed as determined by the determining means (d).

20. The system of claim 11 wherein the antenna system is a multiple-in multiple-out (MIMO) antenna system.

21. A wireless transmit/receive unit (WTRU) comprising a plurality of antennas available for receiving and transmitting antenna signals, the WTRU comprising:
(a) means for analyzing signals received by the antennas;
(b) means for determining, based on at least one signal characteristic, at least one of the antenna signals that is better than other ones of the antenna signals for receiving or transmitting; and
(c) means for selecting the at least one antenna associated with the at least one better antenna signal determined by the determining means.

22. The WTRU of claim 21 wherein the antennas are comprised by a Shelton-Butler matrix fed circular array including a plurality of selectable mode ports.

23. The WTRU of claim 21 wherein the signal characteristic is antenna cross-correlation.

24. The WTRU of claim 23 wherein the at least one antenna signal determined by the determining means has a lower cross-correlation characteristic than the other antenna signals.

25. The WTRU of claim 24 wherein cross-correlation measurement values vary between 0 and 1, where a result of 0 indicates that two signals measured to determine cross-correlation are orthogonal to each other.

26. The WTRU of claim 21 wherein the signal characteristic is associated with the amount of multipath in the antenna signals.

27. The WTRU of claim 26 wherein the at least one antenna signal determined by the determining means has higher multipath than the other antenna signals.

28. The WTRU of claim 21 further comprising:
(d) means for determining how many of the available antennas are needed for at least one of receiving and transmitting the antenna signals.

29. The WTRU of claim 21 further comprising:
(d) means for determining whether or not signal patterns emanated by the at least one selected antenna need to be adjusted; and
(e) means for adjusting the signal patterns if an adjustment is needed as determined by the determining means (d).

30. A base station comprising a plurality of antennas available for receiving and transmitting antenna signals, the base station comprising:
(a) means for analyzing signals received by the antennas;
(b) means for determining, based on at least one signal characteristic, at least one of the antenna signals that is better than other ones of the antenna signals for receiving or transmitting; and
(c) means for selecting the at least one antenna associated with the at least one better antenna signal determined by the determining means.

31. The base station of claim 30 wherein the antennas are comprised by a Shelton-Butler matrix fed circular array including a plurality of selectable mode ports.

32. The base station of claim 30 wherein the signal characteristic is antenna cross-correlation.

33. The base station of claim 32 wherein the at least one antenna determined by the determining means has a lower cross-correlation characteristic than the other antennas.

34. The base station of claim 33 wherein cross-correlation measurement values vary between 0 and 1, where a result of 0 indicates that two signals measured to determine cross-correlation are orthogonal to each other.

35. The base station of claim 30 wherein the signal characteristic is associated with the amount of multipath in the antenna signals.

36. The base station of claim 35 wherein the at least one antenna signal determined by the determining means has higher multipath than the other antenna signals.

37. The base station of claim 30 further comprising:
(d) means for determining how many of the available antennas are needed for at least one of receiving and transmitting the antenna signals.

38. The base station of claim 30 further comprising:
(d) means for determining whether or not signal patterns emanated by the at least one selected antenna need to be adjusted; and
(e) means for adjusting the signal patterns if an adjustment is needed as determined by the determining means (d).

39. An integrated circuit (IC) for controlling an antenna system comprising a plurality of antennas available for receiving and transmitting antenna signals, the IC comprising:
(a) means for analyzing signals received by the antenna;
(b) means for determining, based on at least one signal characteristic, at least one of the antenna signals that is better than other ones of the antenna signals for receiving or transmitting; and
(c) means for selecting the at least one antenna associated with the at least one better antenna signal determined by the determining means.

40. The IC of claim 39 wherein the signal characteristic is antenna cross-correlation.

41. The IC of claim 40 wherein the at least one antenna determined by the determining means has a lower cross-correlation property than the other antennas.

42. The IC of claim 41 wherein cross-correlation measurement values vary between 0 and 1, where a result of 0 indicates that two signals measured to determine cross-correlation are orthogonal to each other.

43. The IC of claim 39 wherein the signal characteristic is associated with the amount of multipath in the antenna signals.

44. The IC of claim 43 wherein the at least one antenna signal determined by the determining means has higher multipath than the other antenna signals.

45. The IC of claim 39 further comprising:
(d) means for determining how many of the available antennas are needed for at least one of receiving and transmitting the antenna signals.

46. The IC of claim 39 further comprising:
(d) means for determining whether or not signal patterns emanated by the at least one selected antenna need to be adjusted; and
(e) means for adjusting the signal patterns if an adjustment is needed as determined by the determining means (d).

47. In an antenna system including a matrix fed circular antenna array having a plurality of mode ports available for receiving and transmitting antenna signals, a method comprising:
(a) analyzing antenna signals received from the mode ports of the matrix fed circular array;
(b) based on at least one signal characteristic, determining at least one of the antenna signals that is better than other ones of the antenna signals for receiving or transmitting; and
(c) selecting the at least one mode port associated with the at least one better antenna signal determined in step (b).

48. The method of claim 47 wherein the circular array is a Shelton-Butler matrix fed circular array.

49. The method of claim 47 further comprising:
(d) determining how many of the available mode ports are needed for at least one of receiving and transmitting the antenna signals.

50. An antenna system comprising:
(a) a matrix fed circular array having a plurality of mode ports available for receiving and transmitting antenna signals;
(b) means for analyzing antenna signals received from the mode ports of the matrix fed circular array;
(c) means, based on at least one signal characteristic, for determining at least one of the antenna signals that is better than other ones of the antenna signals for receiving or transmitting; and
(d) means for selecting the at least one mode port associated with the at least one better antenna signal determined in step (b).

51. The system of claim 50 wherein the circular array is a Shelton-Butler matrix fed circular array.

52. The system of claim 50 further comprising:
(d) means for determining how many of the available mode ports are needed for at least one of receiving and transmitting the antenna signals.
